(19) United States
(12) Patent Application Publication
(10) Pub. No.: US 2007/0082091 A1
(43) Pub. Date: Apr. 12, 2007

(54) Pizza sandwich

(76) Inventors: Kulsoom L. Klavon, Fort Worth, TX (US); George Philip Butler, Alpharetta, GA (US)

Correspondence Address: FOLEY & LARDNER LLP, 321 NORTH CLARK STREET, SUITE 2800, CHICAGO, IL, 60610-4764, US

(21) Appl. No.: 11/245,573

(22) Filed: Oct. 7, 2005

(51) Int. Cl. A21D 13/00

(52) U.S. Cl. 426/94

(57) ABSTRACT

A food item comprises a first bread layer which comprises a first side and a second side. A second bread layer is provided which comprises a first side and a second side wherein at least one of said first side of the first bread layer and the second side of the second bread layer carries at least one pizza topping ingredient thereon. The second side of the first bread layer and the first side of the second bread layer overlie and face one another. Also included is at least one sandwich filler item positioned in between the second side of the first bread layer and the first side of the second bread layer. A method for assembling the same is provided.

### FIELD OF THE INVENTION

The present invention relates to a food item, more particularly, to a food item including pizza and a method for making the same.

### SUMMARY OF THE INVENTION

The present invention provides a food item, which comprises a first bread layer which comprises a first side and a second side and a second bread layer comprises a first side and a second side wherein at least one of said first side of the first bread layer and the second side of the second bread layer carries at least one pizza topping ingredient thereon. The second side of the first bread layer and the first side of the second bread layer overlie and face one another. At least one sandwich filler item is positioned in between the second side of the first bread layer and the first side of the second bread layer.

The present invention provides a method for assembling a food item, which comprises providing a first bread layer and second a second bread layer, wherein each of the first and second bread layers each comprise a first and second side. The invention further provides placing a pizza topping ingredient on at least one of the first side of the first bread layer and the second side of the second bread layer and placing at least one sandwich filler item on at least one of the second side of the first bread layer and the first side of the second bread layer. The method further includes positioning the first bread layer and second bread layer in overlying position with one another with the second side of the first bread layer and the first side of the second bread layer facing one another and the at least one sandwich filler positioned therebetween.

The present invention further provides a method for making a food item which comprises providing a first and second bread layer wherein each of the two bread layers include generally a parallelogram shape construction and comprises two opposing corners. The method further provides positioning a first side of the first bread layer and a second side of the second bread layer facing upwardly wherein a line connecting the opposing corners within each parallelogram shape positions those lines in a converging direction relative to one another. The method of the present invention further provides placing at least one pizza topping ingredient on at least one of the first side of the first bread layer and the second side of the second bread layer.

### BRIEF DESCRIPTION OF THE DRAWINGS

FIG. 1 is a top plan view of two parallelogram shaped pieces of pizza of the present invention with the sides carrying pizza toppings facing upwardly;

FIG. 2 is a side elevational view of a first parallelogram piece of pizza of FIG. 1 turned upside down and sandwich filler items positioned overlying the former bottom side and the other parallelogram piece of pizza being positioned partially upturned with its bottom side to be positioned over the sandwich filler items;

FIG. 3 is a side elevational view of the assembled invention of FIG. 2;

FIG. 4 is a top perspective view of the assembled invention of FIG. 3 showing a line of cutting of the assembled invention; and

FIG. 5 is a top perspective view of the cut portions in FIG. 4 separated.

### DETAILED DESCRIPTION

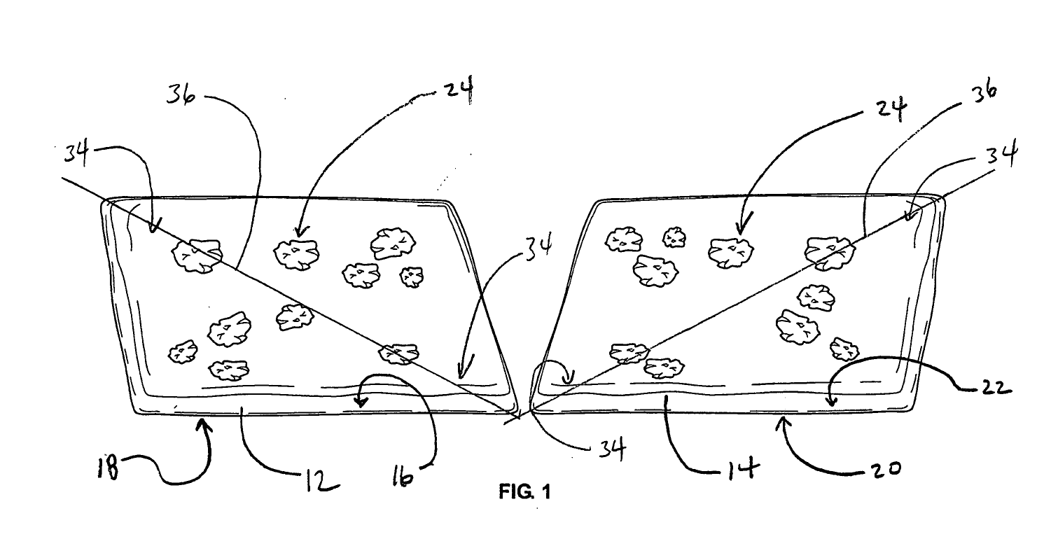

Referring now to the drawings, FIGS. 1-5, one embodiment of food item 10 of the present invention comprises a first bread layer 12 and a second bread layer 14. First bread layer 12 includes a first side 16, which in this embodiment is a top side of bread layer 12 and includes a second side 18, which in this embodiment is a bottom side of bread layer 12, as seen in FIG. 1. Second bread layer 14 includes a first side 20, which in this embodiment is a bottom side of bread layer 14 and includes a second side 22, which in this embodiment is a top side of bread layer 14, as seen in FIG. 1. It is well understood that there are a wide variety of bread products contemplated for this invention. The term “bread” as used herein, shall mean a leavened or unleavened mixture of flour or ground meal which is cooked or otherwise heated. An example of an embodiment of bread will be presented in more detail hereinafter.

Food item 10 further includes at least one of first side 16 and second side 22, of first and second bread layers 12,14 respectively, carries at least one pizza topping ingredient 24 thereon, as seen in FIG. 1. It is understood that pizza topping ingredient 24, for purposes of the present invention, is contemplated to include a wide variety of food items. Pizza topping ingredient 24 will be discussed in more detail below including providing examples of embodiments of the present invention.

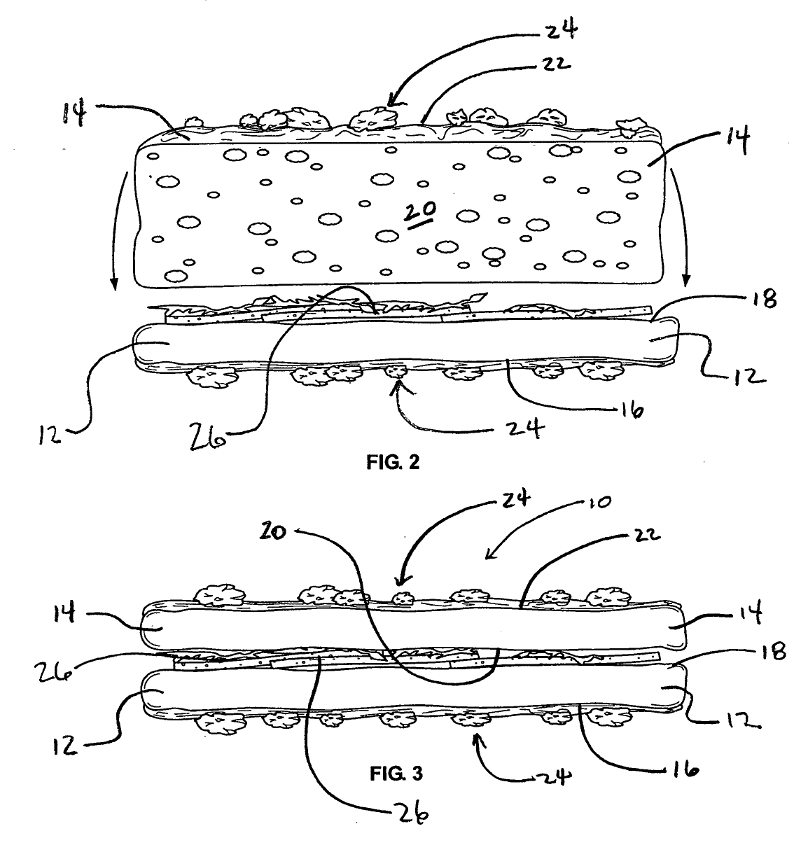

As seen in FIG. 2, first bread layer 12 is turned upside down with second side 18 now facing upwardly in this embodiment. Second bread layer 14 is being placed over first bread layer 12 such that first side 20 of second bread layer 14 is facing and overlying second side 18 of first bread layer 12.

At least one sandwich filler 26 is positioned in between second side 18 of first bread layer 12 and first side 20 of second bread layer 14. It is understood that sandwich filler 26, for purposes of the present invention, is contemplated to include a wide variety of food items. Sandwich filler 26 will be discussed in more detail below including providing examples of embodiments of the present invention.

In the embodiment shown in FIGS. 1-3, it is shown that both first side 16 of first bread layer 12 and second side 22 of second bread layer 14 both carry at least one pizza topping ingredient 24. It is contemplated that one external side of food item 10 may carry a pizza topping ingredient 24.

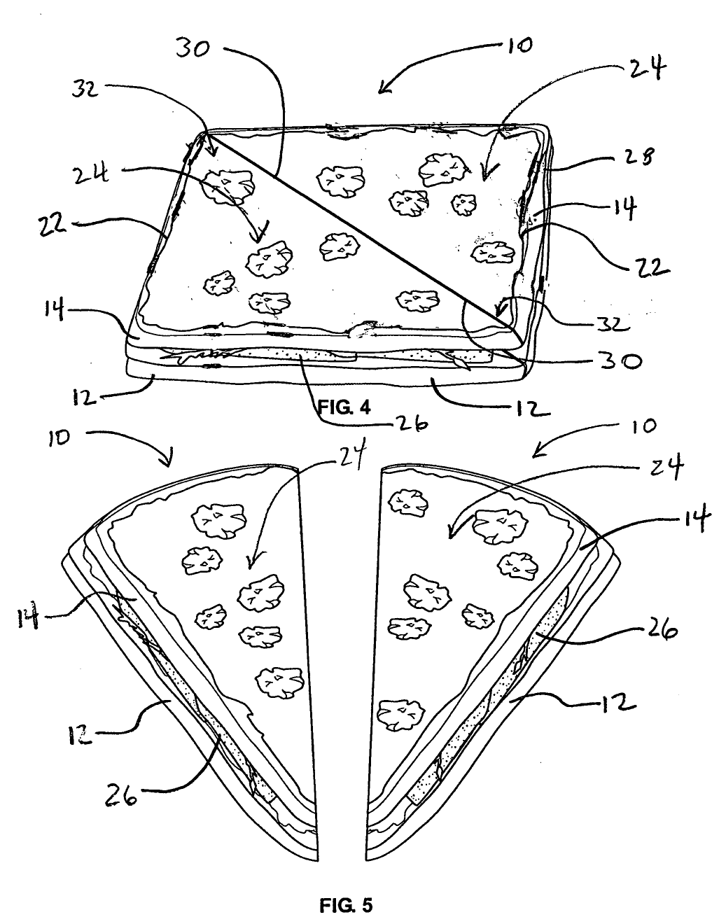

As shown in the embodiment in FIG. 5, first and second bread layers 12,14 can be constructed into a triangular shape. It is contemplated that bread layers 12,14 can take on various shapes and that each layer may be the same shape or they each may be a different shape from the one another. In addition, this embodiment includes first and second bread layers 12,14 being approximately the same dimensions. Again, it is contemplated that bread layers 12,14 can each be constructed of different dimensions. As seen in FIGS. 2-5, first and second bread layers 12,14 are positioned in registration with one another other embodiments may include the layers are not in registration with one another.

Char lines (not shown) may be positioned on one or both of second side 18 of first bread layer 12 and first side 20 of second bread layer 14. Char lines provide a desirable appearance and texture to the bread layers and are typically imparted to a surface of a bread layer during the cooking process of the bread layer. A surface upon which the bread layer is in contact with imparts a localized temperature sufficient to char the surface of the bread layer.

With respect to bread layers 12,14, an example of a recipe for such bread layers is set forth.

### Bread Example 1

| Ingredient | Baker's Percentages |
|---|---|
| Enriched wheat flour | 100% |
| Water | 65% |
| Whey | 10% |
| Soybean oil | 8% |
| Yeast | 3% |
| Sugar | 3% |
| Salt | 2% |
| Dough conditioner: wheat flour, defatted | 8.5% |
| soy flour, vegetable gum, mono and | |
| diglycerides, dextrose, enzymes, L- | |
| Cysteine | |
| Baking powder: sodium acid | 2% |
| pyrophosphate, sodium bicarbonate, | |
| corn starch, monocalcium | |
| phosphate | |
| Vital wheat gluten | 4% |
| Sodium stearoyl lactylate | 0.5% |
| Calcium propionate (added as a | 0.5% |
| preservative) | |

A Baker's Percentage, for example, could utilize 100 pounds of flour for the table above. The subsequent percentages for the other ingredients would require multiplying that percentage times the 100 pounds to give the weight of that particular ingredient. For example, for salt at 2% the weight of salt to be used in this recipe would be 2% times 100 pounds, or 2 pounds.

The recipe mixtures are made and the resulting dough, in one embodiment, is die cut into parallelogram shapes as seen in FIG. 1. The dough shapes are then passed through a tunnel oven and baked at a temperature of approximately 900 degrees Fahrenheit for approximately 40 seconds. The parallelogram shaped bread layers are selectively frozen depending on when and where pizza topping ingredient 24 is applied to the bread layers.

As mentioned earlier, pizza topping ingredient 24 is contemplated by today's culinary world to include a wide variety of food items. Pizza topping ingredient 24 as used herein, shall mean any one or combination of a cheese, meat, poultry, seafood, vegetable, sauce, herb, fruit, spice, spread and condiment. It is understood that any one of these food items can be used by itself as a pizza topping ingredient 24 or be used in any combination with one another. One of the more commonly known pizza topping ingredients 24 would include any type of cheese. Likewise, any meat, poultry and/or seafood or any vegetable can be utilized as pizza topping ingredient 24. In addition, any herb, spice and/or fruit may be used a pizza topping ingredient 24.

Pizza topping ingredient 24 may also include a wide variety of sauces. A traditional sauce may include tomato within the sauce or be constructed as an alfredo sauce and other well-known Italian sauces. Sauces as used herein shall mean a flavored liquid designed to accompany food and to enhance or bring out its flavor. The French are credited with refining the sophisticated art of sauce making. It was the 19^{th} century French chef Antonin Careme who evolved an intricate methodology by which hundreds of derivative sauces were classified under one of four mother sauces. Those are espagnole (brown stock-based), veloute (white stock based, bechamel (milk based), and allemande (egg enriched veloute). Add to these a fifth group—emulsified sauces, such as hollandaise and mayonnaise. Myriad variations may be created from these five basic sauces by adding ingredients such as cheese, cream, garlic, herbs, shallots, spices and so on.

Likewise, pizza topping ingredient 24 may include a numerous variety of spreads. Spreads as used herein shall mean a food item or mixture of food items which is in a semi-solid, gel-like, paste-like consistency to permit the item to be spread over a surface such as on a surface of bread designed to accompany food and to enhance or bring out its flavor. The flavor can be sweet, salty, savory, spicy and/or sour. Commonly known spreads can include such items as peanut butter, butter, flavored butters, jellies, marmalades, jams, chocolate, flavored emulsified sauces, cream cheese, pesto and other commonly known spreads are contemplated for this invention.

Additionally, pizza topping ingredient 24 can include a condiment. A condiment as used herein shall mean a savory, piquant, spicy or salty accompaniment to food, such as a relish, sauce, mixture of spices and the like. Ketchup, mustard and mayonnaise and the like are two of the most popular condiment examples. Other commonly known condiments are contemplated for this invention.

The following are several examples of different embodiments of pizza topping ingredients 24 the present invention.

| | | |
|---|---|---|
| Ingredient | Formula | Oz. per slice |

Topping Ingredients Example 1
Pepperoni

| | | |
|---|---|---|
| Crust (single bread layer)¹ | 61.64% | 2.25 oz. |
| Italian spread (sauce)² | 13.70% | 0.50 oz. |
| No Char Pepperoni³ (8 | 10.96% | 0.40 oz. |
| pieces) | | |
| Part skim mozzarella⁴ | 13.70% | 0.50 oz. |
| | 100.00% | 3.65 oz. |

Topping Ingredients Example 2
Mozzarella & Cheddar

| | | |
|---|---|---|
| Crust (single bread layer)¹ | 69.23% | 2.25 oz. |
| Italian spread (sauce)² | 15.38% | 0.50 oz. |
| Cheese blend: 50% part | 15.38% | 0.50 oz. |
| skim mozzarella⁴, | 100.00% | 3.25 oz. |
| 50% cheddar cheese | | |

Topping Ingredients Example 3
Mozzarella & Parsley

| | | |
|---|---|---|
| Crust (single bread layer)¹ | 69.21% | 2.25 oz. |
| Italian spread (sauce)² | 15.38% | 0.50 oz. |
| Part skim mozzarella⁴ | 15.38% | 0.50 oz. |
| Dry parsley | 0.03% | 0.001 oz. |
| | 100.00% | 3.26 oz. |

¹The bread layer is not a topping ingredient, but is provided for understanding of the weight breakdown of a single bread layer carrying the topping ingredients
²The Italian spread sauce is manufactured by Mullins Food Products of Broadview, IL having code number formula #5350.
³The No Char Pepperoni is manufactured by Tyson Foods of Springdale, AR and/or Hormel Foods of Austin, MN having code number 4041 (Tyson).
⁴Part skim mozzarella is manufactured by Foremost Farms of Baraboo, WI having code number CI 10120038.

In the above examples, pizza topping ingredients 24 are generally applied to the bread layers by applying the Italian sauce directly to the bread layer and then meat and cheese are placed onto the sauce. The bread layer with the pizza topping ingredients 24 positioned thereon is passed through a melter or heating device to melt the cheese.

As to sandwich fillers 26, again, it is well understood that this item contemplates a wide variety of food items with respect to this invention. As was described for pizza topping ingredients 24, sandwich fillers 26 can comprise any one or combination of food items herein discussed. Sandwich fillers 26, as used herein shall mean any one or combination of a lettuce, vegetable, cheese, meat, poultry, seafood, greens, sauce, herb, fruit, spice, spread and condiment.

All but two of these food item categories have been previously discussed above for pizza topping ingredient 24. The two remaining categories include lettuce and greens. As for lettuce, it is contemplated that a wide variety of lettuces can be used with the present invention. As for greens, greens as used herein shall mean edible leaves of certain plants such as beet, collard, spinach, dandelion and turnip.

The following are several examples different embodiments of sandwich filler 26 food items of the present invention.

### Sandwich Filler Example 1

Turkey & Pepperoni on Pepperoni Flatbread

| Ingredient | Supplier | Supplier Code | Targeted Weight | Amount |
|---|---|---|---|---|
| Pepperoni | Great Kitchens, | 006-63005 | 3.70 oz. wt. | 1 each |
| Flatbread, top | Inc. of Addison, IL | | | |
| Pepperoni | Great Kitchens, | 006-63005 | 3.70 oz. wt. | 1 each |
| Flatbread, | Inc. of Addison, | | | |
| bottom | IL | | | |
| Value Smoked | Jennie-O Turkey | 8529-02 | 4.00 oz. wt. | 8-9 slices |
| Turkey, sliced | Store of | | | |
| | Wilmar, MN | | | |
| Spicy Deli | Patrick Cudahy | 15621 | 2.00 oz. wt. | 8 slices |
| Pepperoni, | Incorporated of | | | |
| presliced, .25 oz. | Cudahy, WI | | | |
| Romaine Lettuce | Local Produce | | 1.25 oz. wt. | 2-3 leaves |
| Leaves | | | | 2 layers |
| Parmesan Ranch | Sub Recipe | | 1.50 oz. wt. | |
| Spread | #1080A | | | |
| | Mixture of: | | | |
| | 19 oz. | | | |
| | Hellmann's light | | | |
| | mayonnaise | | | |
| | (Unilever | | | |
| | Foodsolutions of | | | |
| | Lisle, IL | | | |
| | Hellmann's & | | | |
| | Bestfoods product | | | |
| | code #26730 | | | |
| | (#26775 west of | | | |
| | the Rockies), | | | |
| | 1 oz. Hidden | | | |
| | Valley Ranch | | | |
| | dressing (The | | | |
| | Clorox Company | | | |
| | of Oakland, CA), | | | |
| | 64 oz. Sargento | | | |
| | parmesan cheese | | | |
| | (Sargento Foods | | | |
| | Inc. of Plymouth, | | | |
| | WI) | | | |

### Sandwich Filler Example 2

Mexican Beef & Pepperoni on Pepperoni Flatbread

| Ingredient | Supplier | Supplier Code | Targeted Weight | Amount |
|---|---|---|---|---|
| Pepperoni | Great Kitchens, | 006-63005 | 3.70 oz. wt. | 1 each |
| Flatbread, top | Inc. of Addison, IL | | | |
| Pepperoni | Great Kitchens, | 006-63005 | 3.70 oz. wt. | 1 each |
| Flatbread, | Inc. of Addison, | | | |
| bottom | IL | | | |
| Mexican Beef | Burke | 24795 | 1.00 oz. wt. | |
| Crumbles, pre- | Corporation of | | | |
| cooked | Nevada, IA | | | |
| Spicy Deli | Patrick Cudahy | 15621 | 1.00 oz. wt. | 4 slices |
| Pepperoni, | Incorporated of | | | |
| presliced, .25 oz. | Cudahy, WI | | | |
| Ripe Black | Local Purchase | | .30 oz. wt. | |
| Olives, sliced, | | | | |
| drained | | | | |
| Sliced-Sweet | Mancini Foods of | 00630 | .50 oz. wt. | |
| Fried Onions, | Zolfo Springs, | | | |
| drained | FL | | | |
| Mushrooms, | American Roland | 44420 | .60 oz. wt. | |
| sliced, drained | Food Corp. of | | | |
| | New York, NY | | | |
| Pizza Cheese | Chef Solutions/ | 794533022 | 1.50 oz. wt. | |
| Sauce | Orval Kent Food | | | |
| | Company of | | | |
| | Schaumburg, | | | |
| | IL | | | |
| Romaine Lettuce | Local Produce | | 1.25 oz. wt. | 2-3 leaves |
| Leaves | | | | 2 layers |

### Sandwich Filler Example 3

Meatball & Parmesan on Cheddar Mozzarella Flatbread

| Ingredient | Supplier | Supplier Code | Targeted Weight | Amount |
|---|---|---|---|---|
| Cheddar | Great Kitchens, | 004-63005 | 3.50 oz. wt. | 1 each |
| Mozzarella | Inc. of Addison, IL | | | |
| Flatbread, top | | | | |
| Cheddar | Great Kitchens, | 004-63005 | 3.50 oz. wt. | 1 each |
| Mozzarella | Inc. of Addison, | | | |
| Flatbread, | IL | | | |
| bottom | | | | |
| Flame Broiled | John Soules | 13328 | 6.00 oz. wt. | 2 each |
| Meatloaf Patty, | Foods of Tyler, | | | |
| 3 oz. | TX | | | |
| Parmesan Spread | Sub Recipe | | 1.00 oz. wt. | |
| | #1220 | | | |
| | Mixture of: | | | |
| | 7 oz. Kraft | | | |
| | extra | | | |
| | heavy | | | |
| | mayonnaise | | | |
| | (Kraft Foods of | | | |
| | Northfield, IL), | | | |
| | 2.5 Sargento | | | |
| | parmesan cheese | | | |
| | (Sargento Foods, | | | |
| | Inc. of Plymouth | | | |
| | WI) | | | |
| Romaine Lettuce | Local Produce | | 1.25 oz. wt. | 2-3 leaves |
| Leaves | | | | 2 layers |
| Sliced-Sweet | Mancini Foods of | 00630 | .75 oz. wt. | |
| Fried Onions, | Zolfo Springs, | | | |
| drained | FL | | | |

### Sandwich Filler Example 4

Southwest Chicken Chorizo on Mozzarella Flatbread

| Ingredient | Supplier | Supplier Code | Targeted Weight | Amount |
|---|---|---|---|---|
| Mozzarella | Great Kitchens, | 005-63005 | 3.50 oz. wt. | 1 each |
| Cheese and | Inc. of Addison, | | | |
| Parsley | IL | | | |
| Flatbread, top | | | | |
| Mozzarella | Great Kitchens, | 005-63005 | 3.50 oz. wt. | 1 each |
| Cheese and | Inc. of Addison, | | | |
| Parsley | IL | | | |
| Flatbread, | | | | |
| bottom | | | | |
| Roasted Chicken | Willow Brook | 58176 | 4.00 oz. wt. | 10-11 slices |
| Log, sliced | Food, Inc. of | | | |
| | Springfield, | | | |
| | MO | | | |
| Chorizo | Burke | 10017 | 1.50 oz. wt. | |
| Crumbles, pre- | Corporation of | | | |
| cooked | Nevada, IA | | | |
| Fiesta Ranch | Nestle S. A. of | 74826-14603-00 | 1.50 oz. wt. | |
| Spread | Vervey, | | | |
| | Switzerland | | | |
| Leaf Lettuce | Local Produce | | 1.25 oz. wt. | 2-3 leaves |
| | | | | 2 layers |

These sandwich fillers 26 are positioned onto the bread layer typically in a conventional and rather traditional fashion in making a sandwich by layering the various sandwich fillers 26 on top of one another.

Another embodiment of the current invention includes a method to assemble food item 10. One embodiment includes providing a first bread layer 12 and a second bread layer 14 wherein the first and second bread layers 12,14 each comprise a first side 16 and 20 respectively and a second side 18 and 22 respectively, as shown in FIG. 1. A pizza topping ingredient 24, as discussed above, is placed on one of the first side 16 of first bread layer 12 and second side 22 of second bread layer 14. In the current embodiment shown in FIG. 1, both first side 16 of first bread layer 12 and second side 22 of second bread layer 14 have pizza topping ingredient 24 positioned thereon.

As shown in FIG. 2, at least one sandwich filler 26, as discussed above, is placed onto second side 18 of first bread layer 12. First and second bread layers 12,14 are positioned in overlying position with one another, as seen in FIGS. 2 and 3, with second side 18 of first bread layer 12 and the first side 20 of second bread layer 14 facing one another, resulting in at least one sandwich filler 26 positioned therebetween.

The method further includes providing first and second bread layers 12,14 to each have generally the same shape of a parallelogram, as seen in FIG. 1 and each be generally of the same dimensions. The resulting structure as seen in the embodiment shown in FIG. 4 is then cut. The cutting results in the sandwich filler 26 and first and second bread layers 12,14 being cut along a line 30 which connects opposing corners 32 of each of the bread layers. This cutting results in one of the embodiments shown in FIG. 5 which becomes two triangularly shaped sandwich or food items 10.

Another embodiment of a method to assemble food item 10 includes providing first and second bread layers 12,14 wherein each of the two bread layers include a parallelogram shape construction, as shown in FIG. 1. Each of the parallelogram shapes include two opposing corners 34. Bread layers 12,14, as seen in FIG. 1, are positioned wherein a first side 16 of the first bread layer 12 and a second side 22 of the second bread layer 14 are facing upwardly or in other words are top sides of the two bread layers. The orientation of these like parallelogram shaped and sized bread layers 12,14 are positioned such that a line 36 connecting the opposing corners 34 within each parallelogram shape positions those lines 36 in a converging direction relative to one another. This orientation of first and second bread layers 12,14 permit the application of pizza topping ingredient 24 to be readily applied at least one of first side 16 of layer 12 and second side 22 of layer 14 or top sides, facing upwardly, of these parallelogram shapes. This orientation for the application of pizza topping ingredient 24 then permits pizza topping ingredient 24 to be positioned on the external sides of food item 10 as seen in FIG. 3. Thus, under this assembly method the parallelogram shapes of the bread layers can be alternated in their orientation, as seen in FIG. 1, and the pizza topping ingredient 24 can be placed on the top sides of these bread layers resulting in the pizza topping ingredient 24 being positioned on the outer surface of food item 10 when the parallelogram shaped bread layers are positioned in registration with one another as seen in FIGS. 2-4.

Although an exemplary embodiments of the invention have been depicted and described in detail herein, it would be apparent to those skilled in the relevant art that various modifications, additions, substitutions and the like can be made without departing from the spirit of the invention. These are therefore considered to be within the scope of the invention as defined in the following claims.

1. A food item, comprising:
a first bread layer comprising a first side and a second side;
a second bread layer comprising a first side and a second side wherein at least one of said first side of the first bread layer and the second side of the second bread layer carries at least one pizza topping ingredient thereon and wherein the second side of the first bread layer and the first side of the second bread layer overlie and face one another; and
at least one sandwich filler item positioned in between the second side of the first bread layer and the first side of the second bread layer.

2. The food item of claim 1 wherein the first side of the first bread layer and the second side of the second bread layer both carry at least one pizza topping.

3. The food item of claim 1 wherein the first and second bread layers are each constructed to include a triangular shape.

4. The food item of claim 3 wherein the triangle shape of each of the first and second bread layers are of the approximately the same dimensions.

5. The food item of claim 1 wherein the first and second bread layers are positioned in registration with one another.

6. The food item of claim 1 wherein at least one of the first and second bread layers carries at least one char line on a surface of the layer.

7. The food item of claim 1 wherein the pizza topping ingredient includes a cheese.

8. The food item of claim 1 wherein the pizza topping ingredient includes one of a meat, poultry and seafood.

9. The food item of claim 1 wherein the pizza topping ingredient includes a vegetable.

10. The food item of claim 1 wherein the pizza topping ingredient includes a sauce.

11. The food item of claim 10 wherein the sauce includes tomato.

12. The food item of claim 1 wherein the pizza topping ingredient includes an herb.

13. The food item of claim 1 wherein the pizza topping ingredient includes a fruit.

14. The food item of claim 1 wherein the pizza topping ingredient includes a spice.

15. The food item of claim 1 wherein the pizza topping ingredient includes a spread.

16. The food item of claim 1 wherein the pizza topping ingredient includes a condiment.

17. The food item of claim 1 wherein the sandwich filler includes a lettuce.

18. The food item of claim 1 wherein the sandwich filler includes a vegetable.

19. The food item of claim 1 wherein the sandwich filler includes a cheese.

20. The food item of claim 1 wherein the sandwich filler includes at least one of a meat, poultry and seafood.

21. The food item of claim 1 wherein the sandwich filler includes a greens.

22. The food item of claim 1 wherein the sandwich filler includes a sauce.

23. The food item of claim 1 wherein the sandwich filler includes an herb.

24. The food item of claim 1 wherein the sandwich filler includes a fruit.

25. The food item of claim 1 wherein the sandwich filler includes a spice.

26. The food item of claim 1 wherein the sandwich filler includes spread.

27. The food item of claim 1 wherein the sandwich filler includes a condiment.

28. A method for assembling a food item, comprising the steps of:
providing a first bread layer and second a second bread layer wherein each of the first and second bread layers each comprise a first and second side;
placing a pizza topping ingredient on at least one of the first side of the first bread layer and the second side of the second bread layer;
placing at least one sandwich filler item on at least one of the second side of the first bread layer and the first side of the second bread layer; and
positioning the first bread layer and second bread layer in overlying position with one another with the second side of the first bread layer and the first side of the second bread layer facing one another and the at least one sandwich filler positioned therebetween.

29. The method of claim 28 in which placing a pizza topping ingredient includes placing on both the first side of the first bread layer and the second side of the second bread layer.

30. The method of claim 28 in which providing includes providing the first and second bread layers each of generally the same shape of generally a parallelogram and each of generally the same dimensions.

31. The method of claim 30 in which positioning includes cutting the at least one sandwich filler and the first and second bread layers along a line connecting opposing corners of each of the bread layers.

32. The method of claim 31 in which cutting includes providing two generally triangular shaped items.

33. The method of claim 28 in which placing at least one pizza topping ingredient includes providing at least one of a cheese, meat, poultry, seafood, vegetable, sauce, herb, fruit, spice, spread and condiment.

34. The method of claim 28 in which placing at least one sandwich filler includes providing at least one of a lettuce, vegetable, cheese, meat, poultry, seafood, greens, sauce, herb, fruit, spice, spread and condiment.

35. A method for assembling a food item, comprising the steps of:
providing a first and second bread layer wherein each of the two bread layers include a general parallelogram shape construction and comprising two opposing corners;
positioning a first side of the first bread layer and a second side of the second bread layer facing upwardly wherein a line connecting the opposing corners within each parallelogram shape positions those lines in a converging direction relative to one another; and
placing at least one pizza topping ingredient on at least one of the first side of the first bread layer and the second side of the second bread layer.

36. The method of claim 35 in which placing includes placing at least one pizza topping ingredient on both of the first side of the first bread layer and the second side of the second bread layer.

37. The method of claim 35 including turning over the first side of the first bread layer and placing the second side of the first bread layer facing upwardly.

38. The method of claim 37 including placing at least one sandwich filler on the second side of the first bread layer.

39. The method of claim 38 in which including placing at least one sandwich filler includes providing at least one of a lettuce, vegetable, cheese, meat, poultry, seafood, greens, sauce, herb, fruit, spice, spread and condiment.

40. The method of claim 38 positioning the first side of the second bread layer to overly the sandwich filler and face the second side of the first bread layer and positioning the at least one sandwich filler there between.

41. The method of claim 40 cutting the two bread layers and the sandwich filler positioned there between along a line joining the opposing corners.

42. The method of claim 35 in which placing at least one pizza topping ingredient includes providing at least one of a cheese, meat, poultry, seafood, vegetable, sauce, herb, fruit, spice, spread and condiment.
